(19) United States
(12) Patent Application Publication
(10) Pub. No.: US 2026/0156404 A1
(43) Pub. Date: Jun. 4, 2026

(54) Use of corrugated and perforated tubes in a nested configuration within a rear loaded horn speaker enclosure to improve the acoustic performance and bass response

(71) Applicant: William Obrien, Dublin (IE)

(72) Inventor: William Obrien, Dublin (IE)

(21) Appl. No.: 19/397,683

(22) Filed: Nov. 21, 2025

(30) Foreign Application Priority Data
Dec. 2, 2024 (IE) 2024/0724

(51) Int. Cl. H04R 1/28

(52) U.S. Cl. CPC H04R 1/2888; H04R 1/2865

(57) ABSTRACT

Use of specialized tubing profiles in a nested configuration within a rear loaded horn speaker enclosure to improve the acoustic performance and bass responses. This invention achieves several acoustic benefits, including increasing the horn speaker's efficiency and improving the bass response. The nested arrangement of tubes of increasing diameter allows for a longer effective horn sound path while maintaining a shorter overall external horn length.

### FIELD OF THE INVENTION

A horn loudspeaker is a loudspeaker or loudspeaker element which uses an acoustic horn to increase the overall efficiency of the driving element. Horn speakers work by increasing the mass of air coupled to the speaker driver and concentrating the sound in a particular direction. This invention is an optimization for rear loaded horn speaker design to increase the efficiency of the horn speaker, reduce the length of the horn body and reduce the high frequency tones exiting the horn.

### BACKGROUND TO THE INVENTION

The shape and length of the horn effects how the sound is radiated from the end of an acoustic horn. Rear loaded horns typically have equivalent horn lengths that are ¼ of lowest sound wavelength that is to be produced. A horn that is to produce a 34 Hertz tone would be 2.5 m long. (A sound of 34 hertz in air has a wavelength of 10 meters. ¼ of 10 meters is 2.5 meters.) In the case or rear loaded horn speakers, it is often desirable to prevent higher frequency tones from being transmitted through the horn to improve sound quality. Attenuation of higher frequency tones within the horn is typically accomplished using geometrical features of the sound path as well as absorbent materials placed at specific points. Horns are often flared along their length to increase the mass of air resonating within the horn to improve low frequency response.

It is often impractical to have long horns in speaker designs so horns are often folded to reduce the external dimensions of the speaker.

### STATEMENT OF INVENTION

This invention proposes using corrugated and perforated tubing within a horn attached to the rear of a speaker driver to achieve the following.

Facilitate longer horn lengths in a shorter speaker enclosure envelope. This is achieved by arranging corrugated tubing sections in a nested configuration within the horn. For example, 3 nested tubes of increasing diameter of length “x” would result in a “3x” long effective horn sound path while maintaining an overall external horn length of “x”.

Attenuate higher frequency tones exiting the horn through the inherent geometry of the corrugated tubing sections.

Increase the effective mass of air vibrating within the horn and facilitate multiple resonance modes through the use of perforations along the length of the corrugated tubing.

Reduce unwanted resonances of the horn outer surfaces through effective management of the pressure gradient along the sound path from the speaker driver to the horn exit through using perforations along the length of the corrugated tubing.

### BRIEF DESCRIPTION OF THE DRAWINGS

There are 3 drawings included with this application.

FIG. 1 is an outline of a typical flared acoustic horn.

FIG. 2 is an outline of a horn using nested, corrugated tube sections in a compact arrangement.

FIG. 3 is an outline showing corrugated and perforated tubing sections.

### DETAILED DESCRIPTION

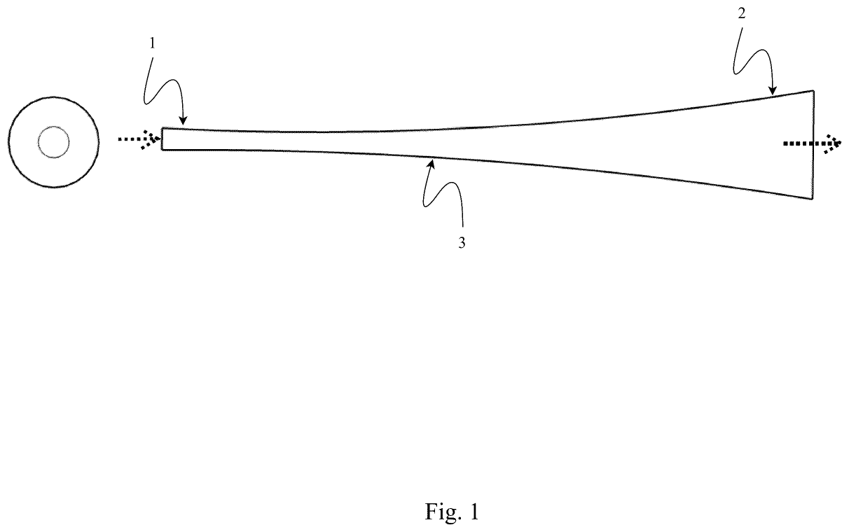

The FIG. 1 drawing represents a typical real loaded acoustic horn and is included for comparison purposes.

The rear side of the speaker driver delivers sound into the horn opening.

The sound travels along the horn and exits at the opening at the end of the horn.

The cross section the horn is shown as circular but can be square, oval, rectangular etc. The walls of the horn can be straight or tapered. The length of the horn typically depends on the lowest frequency it is meant to reproduce with longer horns corresponding to lower frequencies. The volume of air within the horn will also influence the frequency and tone of reproduced sounds. The horn path may be bent or folded to affect the acoustic properties and reduce the overall external dimensions. Materials or geometric features may be added to the horn internals to affect the acoustic properties.

The purpose of this invention is to facilitate better acoustic horn performance than traditional rear loaded horn designs.

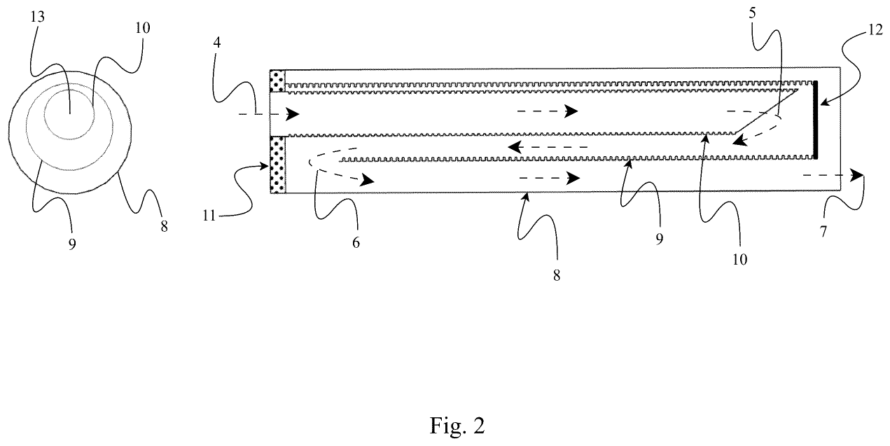

The FIG. 2 drawing shows a nested, folded horn design incorporating the use of corrugated and perforated tubing as part of the horn construction.

The sound enters the smaller diameter corrugated tube at point (4), turns around at point (5) and travels concentrically through the larger diameter corrugated tube before again turning around at point (6) and exiting through the largest diameter outer tube (8) at point (7).

The number, diameter and length of corrugated tube runs used can vary as per the application. The example shown consists of 2 corrugated tubes (9) and (10) and one rigid outer tube (8) for the speaker housing. The corrugated tube ends are sealed at each flow reversal point using a baffle (11) or blanking plate (12) as appropriate.

The centerlines (13) of the nested tubes can be offset to improve sonic performance characteristics as required. Bends and radiuses can be incorporated into the design to further compact the overall dimensions. The nested tubes and outer speaker housing can follow curved paths if required.

It is noted that as the tubes (9) and (10) are perforated, sound pressure can communicate directly between the different chambers in a controlled manner. The amount, distribution and placement of these perforations will influence the resonance and tonal characteristics of the speaker horn. The internal pressure that builds up in the speaker horn can be influenced by the perforations so as to reduce unwanted resonances.

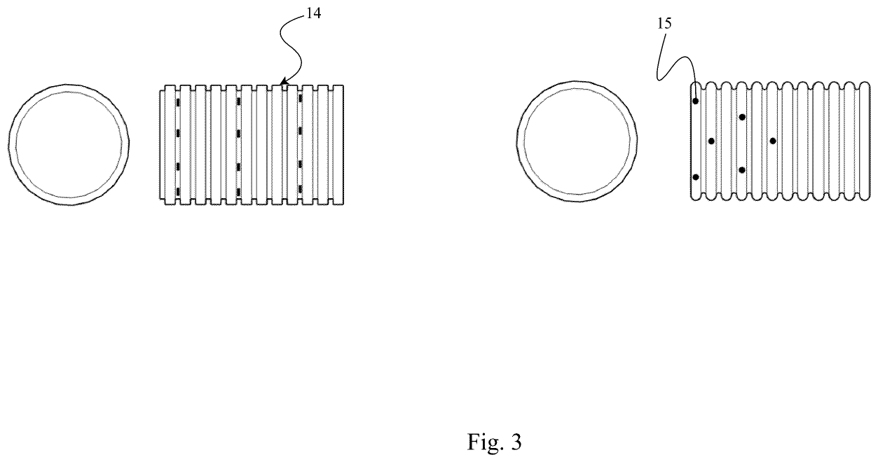

The FIG. 3 drawing shows a closer look at the corrugated and perforated tubing.

The shape, diameter and length of the tubing used can vary per the application. The shape and size of the corrugations (14) on the outside of the tubing can vary per the application. (Square, circular, triangular etc.) The corrugations (14) can be straight or follow a helical path. The corrugations (14) play a key role in reducing the amount of high frequency tones exiting from the horn. The corrugations (14) also improve the resonance characteristics of low frequency tones.

The amount, size, shape and distribution of the perforations on the surface of the tubing (15) can vary per the application. The perforations (15) can dramatically improve the resonance characteristics for low frequency tones. In some portions of the tubing the number and size of perforations (15) can be adjusted as required, such as the section for the outer body of the horn or where the flow path reverses direction.

What is claimed is:

1. A rear loaded horn speaker enclosure comprising a plurality of corrugated tubes of different diameters nested inside each other, and all inside of a rigid outer tube which acts as a housing, wherein the surface of the corrugated tubes contains a plurality of perforations along the length of the tubes.

2. The rear loaded horn speaker enclosure of claim 1, wherein sound pressure communicates directly between adjacent concentric chambers through the perforations to reduce unwanted resonance while maintaining multiple resonance modes.

3. The rear loaded horn speaker enclosure of claim 1, wherein the corrugations attenuate higher frequency tones while the perforations simultaneously increase the effective mass of air vibrating within the horn for enhanced low frequency response.

4. The rear loaded horn speaker enclosure of claim 1, wherein sound travels in a first direction through an inner corrugated perforated tube, reverses direction, and travels in an opposite direction through an outer corrugated perforated tube, with controlled pressure communication between the forward and return paths through the perforations.

5. The rear loaded horn speaker enclosure of claim 1, wherein sound energy from the rear of the speaker driver enters the enclosure from where it communicates across many surface perforations along the length of adjacent nested corrugated tubing sections before subsequent communication with the air outside of the speaker enclosure.

6. A speaker enclosure comprising:
a rigid outer housing;
a speaker driver mounted to the housing;
at least three concentric tubes positioned within the housing and arranged to form a folded acoustic path from the speaker driver to an exit port; and
wherein at least two of the concentric tubes include both corrugations and perforations distributed along their lengths to enable acoustic pressure communication between adjacent concentric spaces while attenuating selected frequency ranges.

7. A method of enhancing acoustic performance in a rear loaded horn speaker enclosure, comprising the steps of:
directing sound waves from a rear side of a speaker driver into a first corrugated tube having perforations along its length;
allowing the sound waves to propagate through the first corrugated tube while simultaneously permitting pressure communication through the perforations to at least one adjacent nested corrugated tube;
reflecting the sound waves at an end of the first corrugated tube to travel in a reverse direction through one or more outer corrugated tubes; and
combining multiple resonance modes created by the nested arrangement while using the perforations to dampen unwanted resonances before the sound exits the enclosure.
